(19) United States
(12) Patent Application Publication
(10) Pub. No.: US 2013/0206954 A1
(43) Pub. Date: Aug. 15, 2013

(54) Portable Beach Umbrella Support Base

(71) Applicants: Bruce Charles Wells, Fords, NJ (US); Gene Stull, JR., Gladstone, NJ (US); Mark Russo, Morristown, NJ (US)

(72) Inventors: Bruce Charles Wells, Fords, NJ (US); Gene Stull, JR., Gladstone, NJ (US); Mark Russo, Morristown, NJ (US)

(21) Appl. No.: 13/397,350

(22) Filed: Feb. 15, 2012

(51) Int. Cl. F16M 13/00

(52) U.S. Cl. 248/523

(57) ABSTRACT

A portable beach umbrella holder for supporting an umbrella in sand. The holder includes a flexible membrane attached to a support mount which receives a portion of the shaft. The support mount includes an upper portion located on one side of the membrane and a lower potion located on the other side of the membrane. The membrane has a hole between the upper and lower portions. The upper and lower portions are attached to one another so as to secure the membrane between them. A bore extends through the upper and lower portions for receiving the umbrella shaft. The upper and lower portions preferably include a center tubular member which defines the bore. The center tubular member in the upper portion is integral with the center tubular member in the lower portion so as to provide the attachment between the upper and lower portions.

### FIELD OF THE INVENTION

The present invention relates to umbrella supports and, more specifically, to a portable umbrella support that provides additionally stability for an umbrella when mounted in sand.

### BACKGROUND

Securing or supporting beach umbrellas in sand at a beach has long been a problem. The current methods for supporting an umbrella include simply driving a sharp end of the umbrella shaft into the sand and then placing a mound of sand around the umbrella shaft; or screwing a secondary bracket into the sand and then inserting the umbrella shaft into a support tube mounted on the bracket.

The current methods for supporting umbrellas, while quite widely accepted, do not always provide enough support for the umbrella when subjected to high wind gusts. When wind enters below the umbrella canopy, it can cause an upward lifting or lateral twisting. In both cases, the small amount of radially extending surface area in the umbrella shaft or the secondary screw mount limits the amount of “lift” or lateral torque that the umbrella mount can withstand before pulling out from the sand.

A need, therefore, exists for an improved umbrella support.

### SUMMARY OF THE INVENTION

A portable beach umbrella holder for providing a support mount in sand. The umbrella includes a canopy secured at one end of a shaft. The holder includes a flexible membrane and a support mount adapted to receive a portion of the shaft. The membrane is attached to the support mount. The support mount includes an upper portion located on one side of the membrane and a lower portion located on the other side of the membrane. The membrane has a hole between the upper and lower portions. The upper and lower portions are attached to one another so as to secure the membrane between them. A bore extends through the upper and lower portions and the hole. The bore is sized to receive a portion of the umbrella shaft.

The upper and lower portions each include a center tubular member which defines the bore. The center tubular member in the upper portion is attached to or integral with the center tubular member in the lower portion so as to provide the attachment between the upper and lower portions.

In one embodiment, the upper portion includes an outer sleeve disposed about and secured to the center tubular member of the upper portion. The upper outer sleeve has an outer diameter that is larger than the hole formed in the membrane so as to prevent the membrane from slipping through. The lower portion may also include an outer sleeve disposed about and secured to the center tubular member of the lower portion. The lower outer sleeve has an outer diameter that is larger than the hole formed in the membrane. The membrane is securely sandwiched between the upper and lower outer sleeves.

### BRIEF DESCRIPTION OF THE DRAWINGS

The above and other aspects, features and advantages of the present invention will be more apparent from the following more particular description thereof, presented in conjunction with the following drawings wherein:

FIG. 1 is an isometric view of a umbrella holder according to the present invention in use supporting an umbrella.

FIG. 2 is an isometric view of the umbrella holder according to the invention illustrating a portion of the flexible support base.

FIG. 3 is a top view of the umbrella holder of FIG. 2.

FIG. 4 is a bottom view of the umbrella holder of FIG. 2.

FIG. 5 is a right side view of the umbrella holder of FIG. 2.

FIG. 6 is a cross-sectional view of the umbrella holder of FIG. 3.

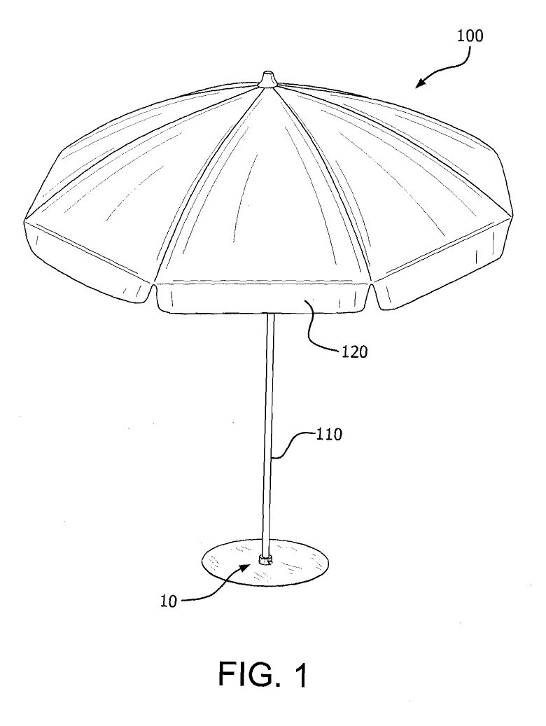

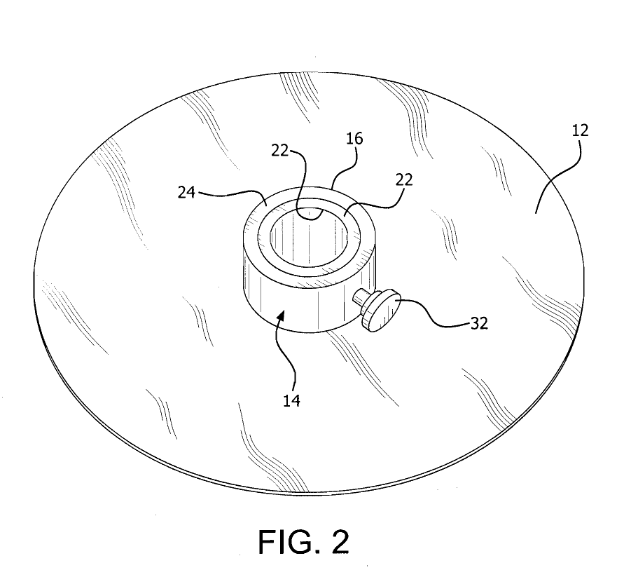

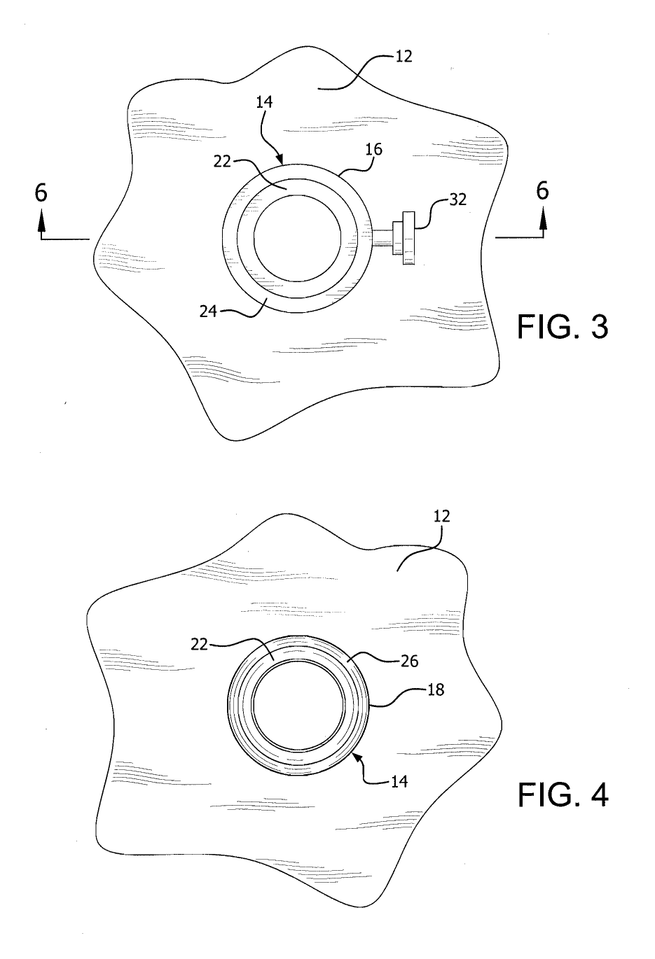

### DESCRIPTION OF THE PREFERRED EMBODIMENTS

Referring now to the figures, there is shown a preferred embodiment of a portable beach umbrella support base 10 for use providing support for an umbrella 100. The umbrella 100 is conventional and includes a shaft 110 that is attached to a folding canopy 120 at a top end. The bottom end of the shaft extends through the base 10 as will be discussed below.

The base of holder 10 includes a flexible brace or membrane 12 which is preferably made from fabric material, such as a PVC coated polyester yarn woven fabric. The material is preferably 0.028 inches thick, which provides for a strong, weather resistant material that is flexible enough to accommodate the intended use. The fabric is preferably cut into a circular pattern with a diameter of between 18-36 inches to form the membrane. However, for thicker, stronger fabrics, a smaller diameter would be useful. Also, the membrane need not be circular, but could be square or any other desired shape. In one preferred embodiment, the membrane 12 has a diameter of approximately 24 inches. The membrane is preferably circular is shape and extends radially outward from a support mount 14.

The support mount 14 includes an upper portion 16 located adjacent to the top surface of the membrane 12 and a lower portion 18 located adjacent to the bottom surface of the membrane 12. The upper and lower portions are preferably attached to one another or to the membrane 12 so as to form a support base. In the illustrated embodiment, the mount 14 includes a central tubular member 20 and an internal bore 22 that is sized to have a diameter that is slightly larger than the diameter of a conventional umbrella shaft 110. In one configuration, the inside diameter 22 of center tubular member 20 is approximately 1.27 inches so as to accommodate a 1.50 inch diameter umbrella shaft. The center tubular member 20 extends through a hole formed in the membrane 12 such that part of the center tubular member 20 is located in the upper portion 16 and part is located in the lower portion 18. The center tubular member 20 preferably has a thickness of approximately 0.375 inches. As will be discussed below, the center tubular member 20 provides a connection between the upper and lower portions for securing the mount 14 to the membrane 12.

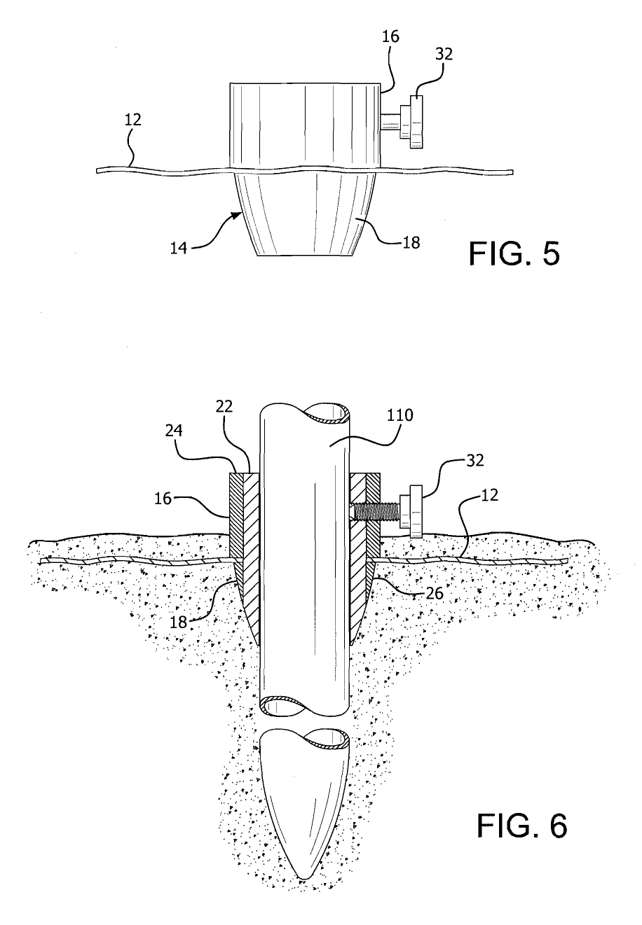

The support mount 14 also includes an upper outer sleeve 24 which is disposed about the central tubular member 20. Preferably the upper outer sleeve 24 is securely mounted to the center tubular member 20, such as by press fitting, fastening or with adhesive. The upper outer sleeve 24 is preferably located adjacent the top surface of the membrane 12 (as shown in FIGS. 5 and 6), and has an outer diameter adjacent to the top surface of the membrane 12 which is larger than the hole formed in the membrane 12. In one embodiment, the upper outer sleeve 24 is made from rubber or plastic material, such as PVC, with a thickness of between about 0.25 inches and about 1.0 inches. In one preferred embodiment, the thickness is 0.970 inches. The upper outer sleeve preferably has an outer diameter of 2.5 includes and an inner diameter of 1.50 inches.

In one embodiment, the support mount 14 includes a lower outer sleeve 26 which is disposed about the center tubular member 20. Preferably the lower outer sleeve 26 is securely mounted to the center tubular member 20, such as by press fitting, fastening or with adhesive. The lower outer sleeve 26 is preferably located adjacent the bottom surface of the membrane 12 (as shown in FIGS. 5 and 6), and has an outer diameter adjacent to the bottom surface of the membrane 12 which is larger than the hole formed in the membrane 12. As shown in the figures, the lower outer sleeve 26 is preferably tapered as it extends away from the bottom surface of the membrane so as to facilitate insertion into the sand during use. In one embodiment, the lower outer sleeve 24 is made from rubber or plastic material, such as PVC, with a thickness at the point where it contacts the bottom surface of the membrane of between about 0.25 inches and about 0.5 inches. Alternatively, the lower outer sleeve 26 may be formed as part of the center tubular member 20. It should be readily apparent that it is possible to reverse the construction such that the upper outer sleeve is formed integral with the center tubular member and the lower outer sleeve is a separate component that attaches to the lower portion of the center tubular member.

As shown in FIG. 6, the upper outer sleeve 24 and the lower outer sleeve 26 sandwich the membrane between them, thus securing the support mount 14 to the membrane 12.

FIG. 6 illustrates a portion of the umbrella shaft 110 extending through the inner bore 22 of the support mount 14. In order to secure the support mount 14 to the shaft, a lock 30 is provided. In one embodiment, the lock is a set screw 32 that is threaded into one or both of the upper outer sleeve 24 and the center tubular member 20 so as to bear into the side, of the shaft 110 forcing it against the side wall of the bore 22. Alternatively, the set screw 32 could thread into a hole formed in one or both of the lower outer sleeve 26 and the center tubular member 20. Also, while a set screw 32 is shown in the figures, it is also contemplated that any conventional locking mechanism can be used, such as a latch that, when flipped, urges the shaft against the bore.

In use, a hole is dug a few inches (approximately 6 inches) down into the sand with a diameter sized to accommodate the diameter of the membrane 12. The support base 10 is slid over the shaft 110 of the umbrella 100 and the shaft end is driven into the center of the cleared area. The membrane 12 is spread open over the cleared area and the lock 30 is actuated so as to secure the support mount 14 to the shaft 110. Sand is then spread over the membrane. The canopy 120 can then be opened. The sand sitting on top of the membrane creates a significantly larger surface to react against lifting twisting loads applied by wind gusts under the canopy. It is estimated that a twenty four inch membrane buried under about six inches of sand can withstand a lifting force of about 150 pounds more than an umbrella simply staked into the ground.

It is also contemplated that each of the upper portion 16 and lower portion 18 could be formed as a single integral unit and then the upper portion could be secured to the lower portion, sandwiching the membrane between them.

While the lower portion 18 is illustrated as being tapered to facilitate insertion into the sand; it is also contemplated that the lower portion could include a screw thread end for threading into the sand.

Although specific embodiments have been described, a person skilled in the art will understand how various modifications may be made within the scope of the present invention, which is defined by the attached claims.

1. A portable beach umbrella holder for providing a support mount in sand, the umbrella including a canopy secured at one end of a shaft, the holder comprising;
a flexible membrane; and
a support mount adapted to receive a portion of the shaft, the membrane being attached to the support mount, the support mount including an upper portion located on one side of the membrane and a lower portion located on the other side of the membrane, the membrane having a hole between the upper and lower portions, the upper and lower portions being attached to one another so as to secure the membrane between them, and a bore extending through the upper and lower portions which is sized to receive a portion of the umbrella shaft.

2. The portable beach umbrella holder of claim 1 wherein the upper and lower portions include a center tubular member which defines the bore, the center tubular member in the upper portion being attached to or integral with the center tubular member in the lower portion so as to provide the attachment between the upper and lower portions.

3. The portable beach umbrella holder of claim 2 wherein the upper portion includes an outer sleeve disposed about and secured to or formed integral with the center tubular member of the upper portion, the upper outer sleeve having an outer diameter that is larger than the hole formed in the membrane; and wherein the lower portion includes an outer sleeve disposed about and secured to or formed integral with the center tubular member of the lower portion, the lower outer sleeve having an outer diameter that is larger than the hole formed in the membrane; and wherein the membrane is securely sandwiched between the upper and lower outer sleeves.

4. The portable beach umbrella holder of claim 3 wherein the lower outer sleeve is tapered.

5. The portable beach umbrella holder of claim 3 wherein the flexible membrane is made from a fabric material and has a substantially circular outer periphery.

6. The portable beach umbrella holder of claim 3 further comprising a lock engaged with the upper portion for securing the upper portion to the umbrella shaft when actuated.

7. The portable beach umbrella holder of claim 6 wherein the lock includes a threaded hole formed in the upper portion and a thumb screw threadingly engaged with the hole.

8. A portable beach umbrella holder for providing a support mount in sand, the umbrella including a canopy secured at one end of a shaft, the holder comprising;
a flexible membrane having an outer peripheral edge and a hole extending through the membrane;
a support mount adapted to receive a portion of the shaft, the membrane being attached to the support mount, the support mount including an upper portion located on one side of the membrane, and a lower portion located on the other side of the membrane, the membrane having a hole between the upper and lower portions, the upper and lower portions being attached to one another so as to secure the membrane between them, and a bore extending through the upper and lower portions and the hole in the membrane, the bore sized to receive a portion of the umbrella shaft;
wherein the upper and lower portions each include a center tubular member with an inner annular opening that defines the bore, the center tubular member in the upper portion being attached to or formed integral with the center tubular member in the lower portion so as to provide the attachment between the upper and lower portions;
wherein the upper portion includes an outer sleeve disposed about and secured to the center tubular member of the upper portion, the upper outer sleeve having an outer diameter that is larger than the hole formed in the membrane so as to secure the membrane; and
wherein the lower portion includes an outer sleeve disposed about and secured to the center tubular member of the lower portion, the lower outer sleeve having an outer diameter that is larger than the hole formed in the membrane; and wherein the membrane is securely sandwiched between the upper and lower outer sleeves.

9. The portable beach umbrella holder of claim 8 wherein a least a portion of the lower portion is tapered.

10. The portable beach umbrella holder of claim 8 wherein the flexible membrane is made from a fabric material and has a substantially circular outer periphery.

11. The portable beach umbrella holder of claim 8 further comprising a lock engaged with the upper portion for securing the upper portion to the umbrella shaft when actuated.

12. The portable beach umbrella holder of claim 11 wherein the lock includes a threaded hole formed in the upper portion and a thumb screw threadingly engaged with the hole.

13. The portable beach umbrella holder of claim 8 wherein the upper outer sleeve is secured to the upper center tubular portion through a press fit, and wherein the lower outer sleeve is secured to the lower center tubular portion through a press fit.

14. The portable beach umbrella holder of claim 8 wherein the membrane is made from a PVC coated polyester yarn woven fabric.
